(19) United States
(12) Patent Application Publication
(10) Pub. No.: US 2017/0193308 A1
(43) Pub. Date: Jul. 6, 2017

(54) SYSTEMS AND METHODS FOR PERSONAL SECURITY USING AUTONOMOUS DRONES

(71) Applicant: Clinimetrics S.A., Genval (BE)

(72) Inventors: Mathieu Buyse, Brussels (BE); Mike Blavier, Vilvoorde (BE); Marc Buyse, San Francisco, CA (US); Marc Marchand, Paris (FR)

(21) Appl. No.: 15/051,166

(22) Filed: Feb. 23, 2016

(51) Int. Cl. G06K 9/00; B64D 47/08; H04N 7/18; B64C 39/02

(52) U.S. Cl. CPC G06K 9/00771; B64C 39/024; B64D 47/08; H04N 7/183; G06K 9/0063; B64C 2201/108; B64C 2201/127

(57) ABSTRACT

A security system includes an autonomous unmanned aerial vehicle (UAV) including an airframe with a power source and a propulsive system operatively mounted to the airframe for sustained, autonomous flight of the UAV. A flight control system is operatively connected to the airframe, propulsive system, and power source to control the sustained, autonomous flight of the UAV. An imaging device is mounted to the airframe. A wireless communication device is operatively connected to the imaging device to wirelessly transmit data including images from the imaging device. A remote server is operatively connected to receive the data transmitted wirelessly from the wireless communication device, wherein the remote server is operatively connected to communicate the data to emergency responders.

### BACKGROUND OF THE INVENTION

1. Field of the Invention

The present disclosure relates to security, and more particularly to personal security systems such as used in conjunction with systems for dispatch of police and other emergency responders.

2. Description of Related Art

Unmanned air vehicles (UAVs) including remotely piloted and autonomous systems have been used in a wide variety of applications for surveillance, filming, exploration and other imaging applications. The UAV provides an advantageous platform for filming and imaging, and as the state of UAV art improves, the endurance, payload capacity, and flight controls provide for ever improving abilities of UAVs in filming and imaging applications.

One application for filming and imaging from a UAV platform is security. UAVs have been proposed for video surveillance in security applications, such as described in U.S. Patent Application Publication No. 2015/134143 to Willenborg, hereafter Willenborg. Willenborg describes a security vehicle, e.g., an armored car for transporting valuables, which is followed by a drone that films the vehicle and its surroundings for security purposes. This allows security personnel to monitor the vehicle at each of its drop points to timely respond to any unplanned or emergency incidents. In another example, Willenborg discloses a UAV that follows an adolescent walking alone in public and transmits video, still images, and other data to the adolescent's parent, e.g., via TV or mobile phone.

Such conventional methods and systems have generally been considered satisfactory for their intended purpose. However, there is still a need in the art for improved application of UAVs to personal security and the like. The present disclosure provides a solution for this need.

### SUMMARY OF THE INVENTION

A security system includes an autonomous unmanned air vehicle (UAV) including an airframe with a power source and a propulsive system operatively mounted to the airframe for sustained, autonomous flight of the UAV. A flight control system is operatively connected to the airframe, propulsive system, and power source to control the sustained, autonomous flight of the UAV. An imaging device is mounted to the airframe. A wireless communication device is operatively connected to the imaging device to wirelessly transmit data including images from the imaging device. A remote server is operatively connected to receive the data transmitted wirelessly from the wireless communication device, wherein the remote server is operatively connected to communicate the data to emergency responders.

The airframe can be configured to expand from a collapsed configuration for storage on the person of a user to a deployed configuration for flight. The imaging device can include imaging hardware configured to capture still images and video.

The system can include a tracking device configured to be maintained on the person of a user. A tracker can be mounted to the airframe, wherein the tracker is operatively connected to track the tracking device, and to inform the flight control system to control the UAV to follow the user. The tracking device can be incorporated in a wearable device, e.g., a bracelet.

The system can include a location device operatively connected to the wireless communication device to transmit data pertaining to the position of the UAV to the remote server. The location device can include at least one of a GPS system or a triangulation system based on wireless communication services.

The system can include an emergency detection sensor configured to detect when a user is experiencing an emergency. The sensor can be operatively connected to activate the UAV automatically and initiate transmission of the data to the remote server. The emergency detection sensor can include at least one of an accelerometer for detecting physical trauma, a temperature sensor for detecting thermal distress, a sound sensor for detecting concussive sounds indicative of emergency, or biometric signals sent by a wearable device, such as a user bracelet, including such parameters as cardiac rate. The UAV can be automatically launched by the sensor when certain pre-defined conditions are met, or by the user himself or herself using an emergency button or by throwing the UAV with enough speed to trigger the included accelerometer, for example.

The system can include a memory, e.g., a machine readable memory, operatively connected to the wireless communication device, wherein the memory includes an identification for inclusion in the data so the remote server can identify the UAV, wherein the remote server is operatively connected to a database that includes personal information of the user, wherein the remote server is configured to look up the user's personal information based on the identification included in the data, and to transmit at least some of the personal information to the emergency responders to aid in responding to emergencies. In another embodiment, the memory includes a database that includes personal information of the user, wherein the wireless communication device is configured to include at least a portion of the personal information in the data transmitted to the remote server, and wherein the remote server is configured to transmit at least some of the personal information to the emergency responders to aid in responding to emergencies. The personal information can include personal medical information.

The remote sever can be operated by the emergency responders, wherein the system includes an application operative on the remote server to provide the data from the wireless communications device to the emergency responders. It is also contemplated that the remote server can be operated by a third party service and can be operatively connected to connect with emergency responder services to transmit the data to the emergency responders.

A method of providing personal security includes activating an autonomous UAV in response to an emergency, imaging an area corresponding to the emergency from the UAV, and transmitting data wirelessly from the UAV to a remote server, wherein the data includes images and/or video of the area corresponding to the emergency. Imaging can include imaging the area corresponding to the emergency while following the user with the UAV. Activating the UAV can include activating the UAV in response to at least one of input from a user or sensor input wherein the sensor is of one or more of the types described above.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of a system in accordance with the present disclosure, showing an unmanned aerial vehicle (UAV) imaging a user during an emergency and transmitting data including images and/or video of the emergency to a remote server for use by emergency responders such as police;

FIG. 2 is a schematic view of the UAV of FIG. 1, showing components included in the UAV; and

FIG. 3 is a schematic view of the UAV of FIG. 2, showing the rotors in the non-deployed position.

### DETAILED DESCRIPTION OF THE PREFERRED EMBODIMENTS

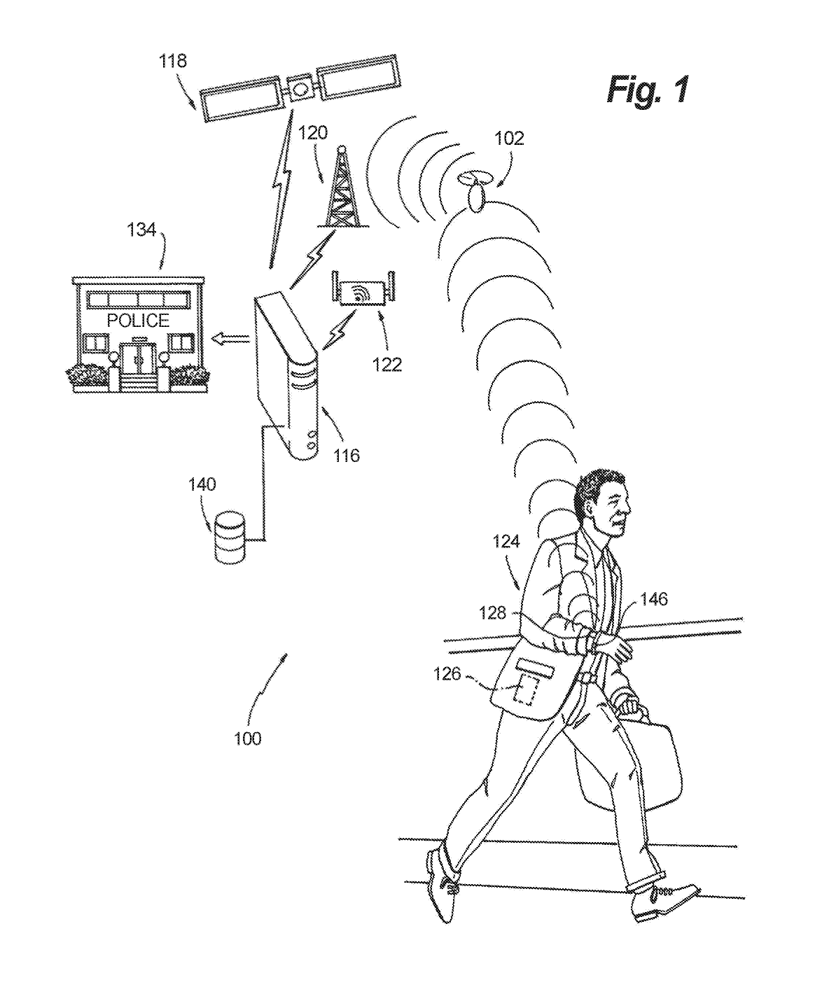

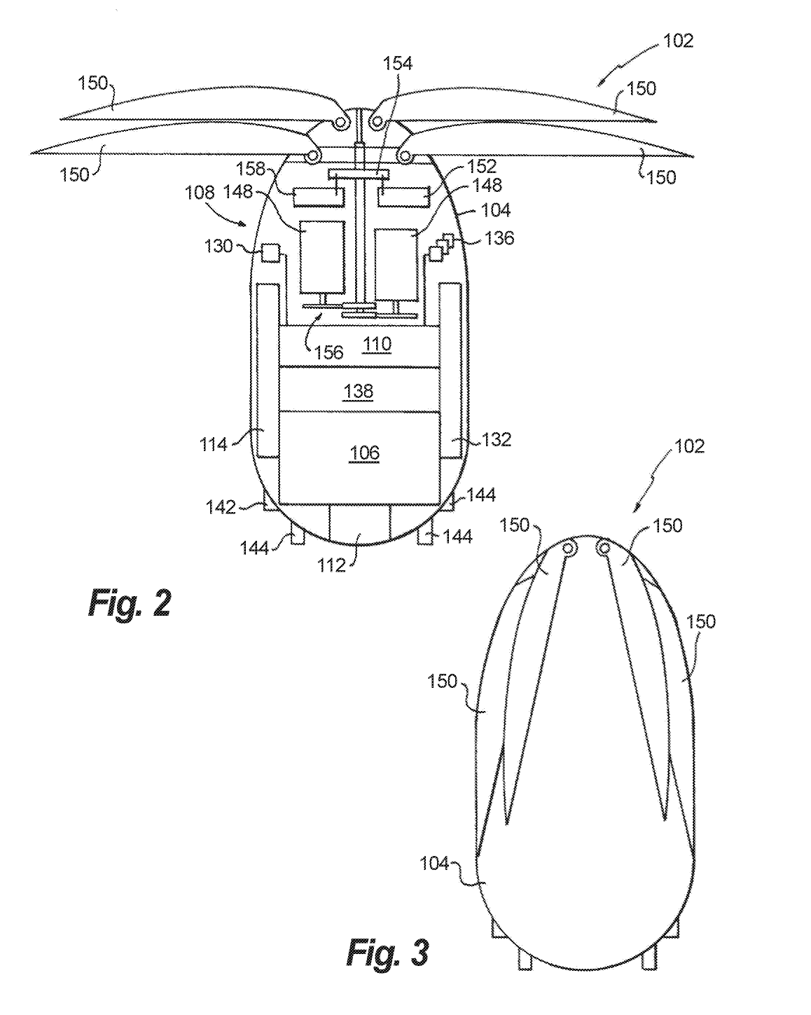

Reference will now be made to the drawings wherein like reference numerals identify similar structural features or aspects of the subject disclosure. For purposes of explanation and illustration, and not limitation, a partial view of an exemplary embodiment of the system in accordance with the disclosure is shown in FIG. 1 and is designated generally by reference character 100. Other embodiments of systems in accordance with the disclosure, or aspects thereof, are provided in FIG. 2, as will be described. The systems and methods described herein can be used for personal security and in aiding response to emergencies by emergency responders.

Security system 100 includes an autonomous unmanned aerial vehicle (UAV) 102. A user 124 can carry the UAV 102 on his or her person. The UAV 102 can be deployed, either by the user 124 or automatically, in the event of an emergency. The UAV 102 transmits data to a remote server 116 to alert emergency responders 134 to the situation. The data can include location data, still images, video images, sound, identification and personal data. The emergency responders 134 can utilize this information and use it in responding to the emergency. The data can be communicated form the UAV 102 to the emergency responders 134 in real time or on a slight delay, so that emergency responders can monitor the situation, e.g., en route to the scene of the emergency, and be informed up to the second of developments in the area of the emergency as they arrive on the scene. It is believed, for example, that data related to the first ten seconds or so of an event can often be critical information for providing timely and appropriate responses from emergency responders 134, and system 100 can provide this information where traditional methods and systems do not.

For example, if a robbery is attempted on user 124, the video feed from UAV 102 can be viewed by police as they are driving to the scene, and the perpetrator can be followed or tracked based on the images provided by UAV 102. In another example, EMT's or ambulance personnel can change their response strategy en route if the video feed shows that user 124 has lost consciousness subsequent to UAV 102 initially signaling for help. In yet another example, in case of a kidnapping, information on the perpetrator (face recognition and vehicle/license plate recognition) is transmitted in real-time as well as stored for further use. Thus, UAV 102 serves as an electronic distress flair, leading emergency responders to the scene and providing information to allow emergency responders to adapt to the specific circumstances even as they are en route.

As shown in FIG. 2, UAV 102 includes an airframe 104 with a power source 106 and a propulsive system 108 operatively mounted to the airframe 104 for sustained, autonomous flight of the UAV 102. A flight control system 110 is operatively connected to the airframe 104, propulsive system 108, and power source 106 to control the sustained, autonomous flight of the UAV 102. The power source 106 and propulsive system 108 are configured to provide a useful duration of sustained flight, while also powering the other components for imaging, data transmission, and flight control. Any suitable type of power supply can be included in power source 106, such as on or more rechargeable batteries including lithium based batteries, single use or chemical batteries, one or more super-capacitors, or any other suitable power supply.

In the exemplary embodiment of FIG. 2, UAV 102 has a coaxial, counter rotating propulsive system 108, which includes a pair of brushless motors 148 each for rotating a respective rotor 150 by way of gear train 156, as well as a set of two micro motors or servos 152 each operatively connected to a cyclic/collective pitch mixing (CCPM) swashplate 154 that is operatively connected for cyclic and collective control of at least one of the rotors 150. Rotors 150 can move from a non-deployed position as shown in FIG. 3 for storage, e.g., in a pocket of user 124, to a deployed position as shown in FIG. 2 for flight. Those skilled in the art will readily appreciate that any other suitable configuration can be used and that propulsive system 108 can include one or more motors, any applicable power trains, and rotors, fans, ducted fans, propellers, or any other suitable propulsion systems.

An imaging device 112 is mounted to the airframe 104. The imaging device 112 includes imaging hardware configured to capture still images, video, and optionally sound. A wireless communication device 114 is operatively connected to the imaging device 112, e.g., directly as shown in FIG. 2, or by way of flight controller 110 and/or other suitable components, to wirelessly transmit data including still and/or moving images from the imaging device 112. Wireless communication device 114 can include a Global System for Mobile Communications (GSM) device, a Wi-Fi device, a cellular and/or satellite device, or any other suitable communications device or combination of devices.

Referring again to FIG. 1, system 100 includes a remote server 116 that is operatively connected to receive the data transmitted wirelessly from the wireless communication device 114 of UAV 102. Wireless communication device 114 can connect through any suitable wireless system, such as by satellite 118, cell phone network 120 (e.g., using a SIM card), Wi-Fi hotspot 122, or the like. The remote server 116 is also operatively connected to communicate the data to emergency responders 134 such as police, ambulance, and the like.

The airframe 104 of UAV 102 is configured to expand from a collapsed configuration for storage on the person of a user 124 to a deployed configuration for flight as shown in FIG. 1. It is contemplated that UAV 102 in the collapsed configuration can easily be carried on the person of the user 124 until needed, for example within a pocket. For example, in the collapsed state, the UAV 102 can be approximately the size of a cigar, and can way a few ounces (1 ounce equals 28.35 grams). Those skilled in the art will readily appreciate that any suitable UAV airframe configuration can be used without departing from the scope of this disclosure, including helicopter configurations, multi-rotor configurations, fixed-wing configurations, and the like. An example of a UAV that can collapse down to pocket size is described in German Patent Publication No. DE 10 2005 014 949, which is incorporated by reference herein in its entirety.

In an emergency, UAV 102 is deployed from the collapsed configuration and activated to fly and operate data collection and transfer autonomously. Imaging device 112 takes images including stills and/or video of the area surrounding user 124, i.e. the area corresponding to the emergency or accident, and automatically transmits the images and/or other data to the remote server 116, which in turn can forward some or all of the data to the emergency responders 134 for use in aiding the user 124 and/or others involved in the emergency. Since the data is transmitted from UAV 102 immediately, emergency responders 134 can have the benefit of whatever information is transmitted even if for some reason UAV 102 or some other portion of system 100 subsequently fails.

The system 100 can optionally include a tracking device configured to be maintained on the person of a user 124. The tracking device can be incorporated in a wearable device 128, such as a bracelet. The bracelet can also provide biometric data about the user's state including heart rate that can be included in the data of UAC 102, for example. While described herein in the exemplary context of a wearable device such as a bracelet, those skilled in the art will readily appreciate that any other suitable type of tracking device, including tracking devices incorporated in smart phone 126 for example, can be used without departing from the scope of this disclosure. As indicated in FIG. 2, a tracker 130 is mounted to the airframe 104. The tracker 130 is operatively connected to track the tracking device, and to inform the flight control system 110 to control the UAV 102 to follow the user. This assists UAV 102 in filming the user 124 and the surrounding area, even if user 124 moves while UAV 102 is operating. Wearable device 128 can also include an input device 146, e.g., a button, that user 124 can use to cancel deployment of UAV 102, for example if UAV 102 were deployed in error. Input device 146 can include a fingerprint reading device, e.g., to prevent a perpetrator from canceling deployment of UAV 102, and to reduce the chance of a false alarm being sent.

The system 100 includes a location device 132 operatively connected to the wireless communication device 114, e.g., by way of flight controller 110 as shown in FIG. 2, or any other suitable connection, to transmit data pertaining to the position of the UAV 102 to the remote server 116. This will allow server 116 to make the location of the emergency known to the emergency responders 134. The location device 132 can include a GPS system, a triangulation system that utilizes wireless communication services such as cell towers for triangulation, a system that determines location based on Wi-Fi signals, and/or any other suitable location system.

With continued reference to FIG. 2, the system 100 includes one or more emergency detection sensors 136 configured to detect when a user 124 is experiencing an emergency. The one or more sensors 136 are operatively connected to activate the UAV 102 automatically and initiate transmission of the data to the remote server 116. It is also contemplated that the one or more sensors 136 can include an input device allowing the user 124 to activate UAV 102 and initiate the transmission. The one or more sensors 136 can include at least one of an accelerometer for detecting physical trauma, a temperature sensor for detecting thermal distress, a sound sensor for detecting concussive or other sounds indicative of emergency, or a module for receiving biometric signals, e.g., sent by a user bracelet including such parameters as cardiac rate. When the UAV 102 and/or user 124 are subject to conditions that trigger any of the one or more sensors 136, the system 100 becomes operative to alert emergency responders 134. UAV 102 has to be borne in such a manner as to be able to fly freely in order for automatic launch to allow UAV 102 to fly. The UAV 102 can be automatically launched by one or more of the sensors 136 when certain pre-defined conditions are met, or by the user himself or herself using an emergency button on wearable device 128 and/or UAV 102 and/or by throwing the UAV 102 with enough speed to trigger an accelerometer of sensors 136, for example.

Sensors 136 can also include devices for determining height of UAV 102 during flight. An advantageous height for imaging in this context is about 3 to 10 meters (about 10 to 30 feet), and sensors 136 can provide feedback to flight control system 110 to maintain this height. Sensors 136 can also include obstacle or proximity sensing devices, for example to provide feedback for flight control system 110 to avoid obstacles or maintain a flight level just below a ceiling if deployed indoors.

In case obstacles prevent UAV 102 from flying (e.g. within a car, boat or other closed space), the system 100 shown on FIG. 2 can operate nonetheless, e.g. to transmit whatever data is available such as location and personal data. It is contemplated that UAV 102 can be deployed for self-defense/preservation without substantial risk to the user 124 or perpetrators.

Power source 106 of UAV 102 should be routinely charged so that UAV 102 is ready to operate at all needful times. An LED 142 or any other suitable display, can be included in airframe 104 operatively connected to power source 106 to indicate for user 124 when power source 106 is in need of a charge. Flight controller 110 can be configured to have a failsafe feature, e.g. programmed into flight controller 110, that causes UAV 102 to land in a controlled manner if needed, e.g., when the power source 106 is low on power. One or more additional LEDs 144 can be included on airframe 104, operatively connected to power source 106, to be visible to and/or provide illumination of individuals at or around the scene of the event when UAV 102 is deployed.

The system can include a data management component 138, e.g., including a machine readable memory, operatively connected to the wireless communication device 114, e.g., directly, via flight control system 110 as indicated in FIG. 2, or by any other suitable connection. The memory includes an identification for inclusion in the data so the remote server 116 can identify the UAV 102. The remote server 116 can be operatively connected to a database 140, shown in FIG. 1, that includes personal information of the user. This allows the remote server 116 to look up the user's personal information based on the identification included in the data. In another embodiment, the memory of data management device 138 includes a database with the personal information of the user 124, wherein the wireless communication device is configured to include at least a portion of the personal information in the data transmitted to the remote server 116. The remote server 116 is configured to transmit at least some of the personal information to the emergency responders 134 to aid in responding to emergencies. The personal information can include personal medical information, or any other information that may be helpful in appropriate response by emergency responders 134 to a particular user 124 during an emergency.

The remote sever 116 can be operated by the emergency responders 134, e.g. police, ambulance, emergency medical technician (EMT), and/or fire department, wherein the system 100 includes an application operative on the remote server 116 to provide the data from the wireless communications device 114 to the emergency responders 134. It is also contemplated that the remote server 116 can be operated by a third party service and can be operatively connected to connect with emergency responder services to transmit the data to the emergency responders 134.

A method of providing personal security includes activating an autonomous UAV, e.g., UAV 102, in response to an emergency. The method includes imaging an area corresponding to the emergency from the UAV, and transmitting data wirelessly from the UAV to a remote server, e.g., remote server 116. The data includes images and/or video of the area corresponding to the emergency. It is also contemplated that imaging can include imaging the area corresponding to the emergency while following the user with the UAV. Activating the UAV can include activating the UAV in response to at least one of input from a user or sensor input wherein the sensor is of one or more of the types described above.

The methods and systems of the present disclosure, as described above and shown in the drawings, provide for personal security systems and methods with superior properties including real time data transmission to emergency responders to aid in responding to emergencies, where the data includes still images, video images, personal data including medical information and the like. While the apparatus and methods of the subject disclosure have been shown and described with reference to preferred embodiments, those skilled in the art will readily appreciate that changes and/or modifications may be made thereto without departing from the scope of the subject disclosure.

1. A security system comprising:
an autonomous unmanned aerial vehicle (UAV) including an airframe with a power source and a propulsive system operatively mounted to the airframe for sustained, autonomous flight of the UAV;
a flight control system operatively connected to the airframe, propulsive system, and power source to control the sustained, autonomous flight of the UAV;
an imaging device mounted to the airframe;
a wireless communication device operatively connected to the imaging device to wirelessly transmit data including images from the imaging device; and
a remote server operatively connected to receive the data transmitted wirelessly from the wireless communication device, wherein the remote server is operatively connected to communicate the data to emergency responders;
wherein the flight control system includes machine readable program instructions configured to cause the flight control system to:
receive input indicative of an emergency to activate the UAV at a scene of an emergency in response to the emergency;
image an area corresponding to the emergency from the UAV; and
transmit data wirelessly from the UAV to the remote server, wherein the data includes images and/or video of the area corresponding to the emergency.

2. A system as recited in claim 1, wherein the airframe is configured to expand from a collapsed configuration for storage on the person of a user to a deployed configuration for flight.

3. A system as recited in claim 1, wherein the imaging device includes imaging hardware configured to capture still images and video.

4. A system as recited in claim 1, further comprising:
a tracking device configured to be maintained on the person of a user; and
a tracker mounted to the airframe, wherein the tracker is operatively connected to track the tracking device, and to inform the flight control system to control the UAV to follow the user.

5. A system as recited in claim 4, wherein the tracking device is incorporated in a smart phone.

6. A system as recited in claim 5, wherein the tracking device is incorporated in a wearable device separate and distinct from a user's smart phone.

7. A system as recited in claim 1, further comprising:
a location device operatively connected to the wireless communication device to transmit data pertaining to the position of the UAV to the remote server, wherein the location device includes at least one of a GPS system or a triangulation system based on wireless communication services.

8. A system as recited in claim 1, further comprising:
an emergency detection sensor configured to detect when a user is experiencing an emergency, wherein the sensor is operatively connected to activate the UAV automatically and initiate transmission of the data to the remote server.

9. A system as recited in claim 8, wherein the emergency detection sensor includes at least one of an accelerometer for detecting physical trauma, a temperature sensor for detecting thermal distress, a sound sensor for detecting concussive sounds indicative of emergency, or biometric signals sent by a wearable device.

10. A system as recited in claim 1, further comprising a memory operatively connected to the wireless communication device, wherein the memory includes an identification for inclusion in the data so the remote server can identify the UAV, wherein the remote server is operatively connected to a database that includes personal information of the user, wherein the remote server is configured to look up the user's personal information based on the identification included in the data, and to transmit at least some of the personal information to the emergency responders to aid in responding to emergencies.

11. A system as recited in claim 10, wherein the personal information includes personal medical information.

12. A system as recited in claim 1, further comprising a memory operatively connected to the wireless communication device, wherein the memory includes a database that includes personal information of the user, wherein the wireless communication device is configured to include at least a portion of the personal information in the data transmitted to the remote server, and wherein the remote server is configured to transmit at least some of the personal information to the emergency responders to aid in responding to emergencies.

13. A system as recited in claim 12, wherein the personal information includes personal medical information.

14. A system as recited in claim 1, wherein the remote sever is operated by the emergency responders, wherein the system includes an application operative on the remote server to provide the data from the wireless communications device to the emergency responders.

15. A system as recited in claim 1, wherein the remote server is operated by a third party service and is operatively connected to connect with emergency responder services to transmit the data to the emergency responders.

16. A method of providing personal security comprising:
activating an autonomous UAV at a scene of an emergency in response to the emergency;
imaging an area corresponding to the emergency from the UAV; and
transmitting data wirelessly from the UAV to a remote server, wherein the data includes images and/or video of the area corresponding to the emergency.

17. A method as recited in claim 16, wherein the remote server is a server operated by emergency responders.

18. A method as recited in claim 16, wherein the remote server is operated by a third party service with connectivity to transmit the data to emergency responders.

19. A method as recited in claim 16, wherein imaging includes imaging the area corresponding to the emergency while following the user with the UAV.

20. A method as recited in claim 16, wherein activating the UAV includes activating the UAV in response to at least one of input from a user or sensor input wherein the sensor includes at least one of an accelerometer for detecting physical trauma, a temperature sensor for detecting thermal distress, a sound sensor for detecting concussive sounds indicative of emergency, or biometric signals sent by a wearable device.

21. A method as recited in claim 16, wherein the data includes at least one of data indicative of location of the UAV, data identifying the UAV, or personal data relating to a user of the UAV.
